(19) United States
(12) Patent Application Publication
(10) Pub. No.: US 2007/0007334 A1
(43) Pub. Date: Jan. 11, 2007

(54) Mini ATM/credit card, mini bank ID card and mini key/access card

(76) Inventor: Jim B. Wong, Los Angeles, CA (US)

Correspondence Address: WHITE-WELKER & WELKER, LLC, P.O. BOX 199, CLEAR SPRING, MD, 21722-0199, US

(21) Appl. No.: 11/177,181

(22) Filed: Jul. 8, 2005

(51) Int. Cl. G06K 5/00; G07F 19/00; G06K 19/06

(52) U.S. Cl. 235/380; 235/379; 235/493

(57) ABSTRACT

The Mini, ID, and Key cards of the present invention are characterized by a magnetic strip that is shortened with respect to the length of the card, due to the physical size limitation imposed by the physical dimensions of the card. The width of the magnetic strip is increased to recover the lost area as a result of the magnetic strips diminished length while still be compatible with most card reading systems known in the prior art. On the card of the present invention, the background is imprinted with a personal photo and the issuing bank's logo so that the limited surface space can be utilized for other important or necessary information. The cards also include a small thumbnail area at a top end designed to ease card handling for a user and provide an area that can be hole punched into any shape or size.

### CROSS REFERENCE TO RELATED APPLICATIONS

Not Applicable

### TECHNICAL FIELD OF THE INVENTION

The present invention relates generally to access and ID cards. More specifically the present invention relates to access and ID cards for use in the banking and financial industry.

### BACKGROUND OF THE INVENTION

The present invention relates to simple electronic devices that are widely used by banking and financial institutions and the general public. For years, banking and financial institutions have been issuing ATM, ID, and Key cards to customers for accessing accounts at various remote terminals such as automated teller machines (ATMs).

A common problem with ATM, access, and ID cards occurs once a dishonest business obtains information stored on such cards. An unscrupulous business may double charge a card owner, distribute the information in an unauthorized manner, or abuse access to such information in a number of other ways without the acknowledgement and consent of the card holder. It is an object of the present invention to create a system that prevents double charging and the unauthorized dissemination of information stored on such cards. Thus, it is an object of the present invention to provide for a card that is smaller in size and more convenient for a user to carry, store, and use while providing the same, if not more functionality.

It is a common occurrence for users to hole punch a card so that it can be connected to a key loop, card loop, necklace, or wallet when there is provided a Velcro™ strap on the card and inside a wallet. This practice leads to destroyed or damaged cards that may not work properly with a reader causing the user to waste time and energy in an effort to replace the card and creates an additional expense burden on the issuing institution to provide a replacement card, which is typically provided at no cost to the user. It is another object of the invention to provide for a card that provides means for a user to hole punch a card in a manner that is provided for and cannot result in any damage to the card that would effect its functionality.

A keycard is an efficient security device, along with a metal key combination lock and radio lock commonly found on automobiles. It is well known that hotels have been using keycards, however they are big and expensive due to the fact they are re-programmable. Additionally, the readers and writers for keycards are also typically large and expensive. It is an object of the present invention to provide a lower cost and lighter weight alternative to the current keycard system that could have applications beyond hotel services to bus and subway systems, access restriction in commercial settings, personal use and access to electronic devices or physical locations such as a locker or drawer.

It is therefore an object of the present invention combine three of the most frequently used personal items into one owner friendly accessory by reducing the size and weight of each item.

It is another object of the present invention to make the electronic withdraw and purchase of goods and services from a cash account easier and more secure.

### SUMMARY OF THE INVENTION

In accordance with the present invention there is provided an improved access and ID cards for use in the banking and financial industry. These together with other objectives of the invention along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

Its physical dimension in comparison to similar cards known to exist in the prior art characterizes the present invention. The physical embodiment of the card disclosed in the present invention makes it more user-friendly with respect to weight and size.

The mini card of the present invention combines the three of the most frequently used personal items into one owner friendly accessory by reducing the size and weight of each item while simultaneously making the electronic withdraw and purchase of goods and services from a cash account easier and more secure.

The bank ID card of the present invention is added to ATM card verification procedures for extra consumer protection. The bank ID card includes important personal information such as social security number, citizenship, and driver's license number. In an alternative embodiment, a bank can even edit a clients' credit history into his/her bank ID card. A bank ID card that has this important information could be recognized between banks, eliminating the need for a new application when one applies for a new account with a bank, by simply providing the new bank with the current bank ID card.

The key card of the present invention enables secured access into personal space and belongings.

### BRIEF DESCRIPTION OF THE DRAWINGS

FIG. 1 illustrates a front view of the mini ATM card of the present invention;

FIG. 1a illustrates a back view of the mini ATM card of the present invention;

FIG. 2a illustrates a side view of the mini ATM card of the present invention;

FIG. 2b illustrates a side view of the Mini Id/Access card of the present invention;

FIG. 3 illustrates a front view of the Mini Id/Access card of the present invention;

FIG. 4 illustrates a back view of the Mini Id/Access card of the present invention;

FIG. 5 illustrates a front view of the mini key card of the present invention;

FIG. 6 illustrates the twin flow chart of the present invention;

FIG. 7 illustrates the dual verification process.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention. The invention is an improved ATM, access, and ID card 100 for use in the banking and financial industry.

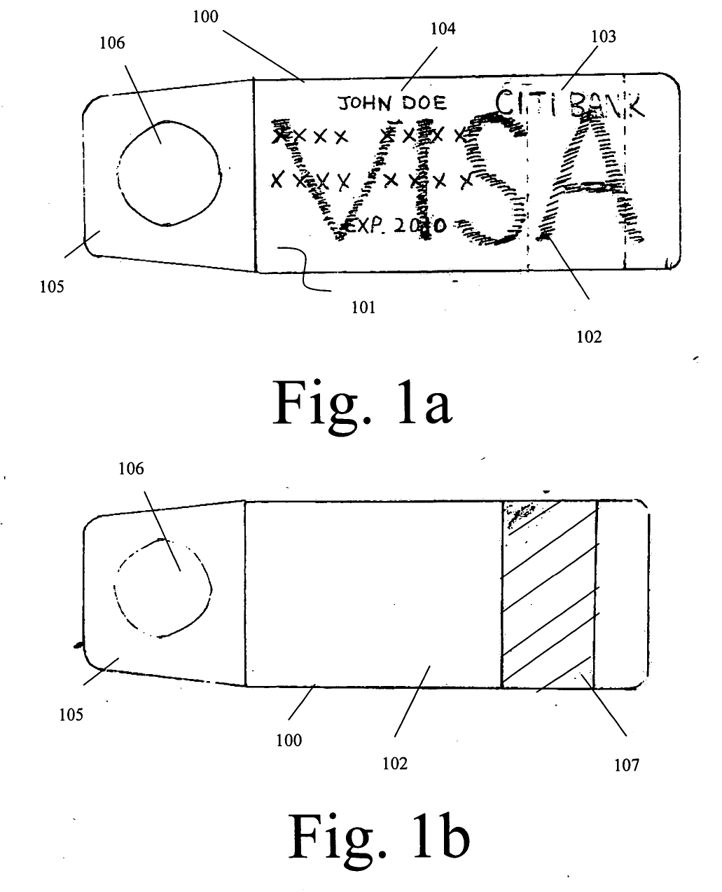

Now referring to FIG. 1a, the major elements of the present invention consist of an access card 100 wherein the front card face 101 includes a network logo 102, issuer logo 103, client information 104, handling area 105, opening in the handling area 106, and a magnetic strip 107. A preferred embodiment of the present invention is described herein and shown in the Figures.

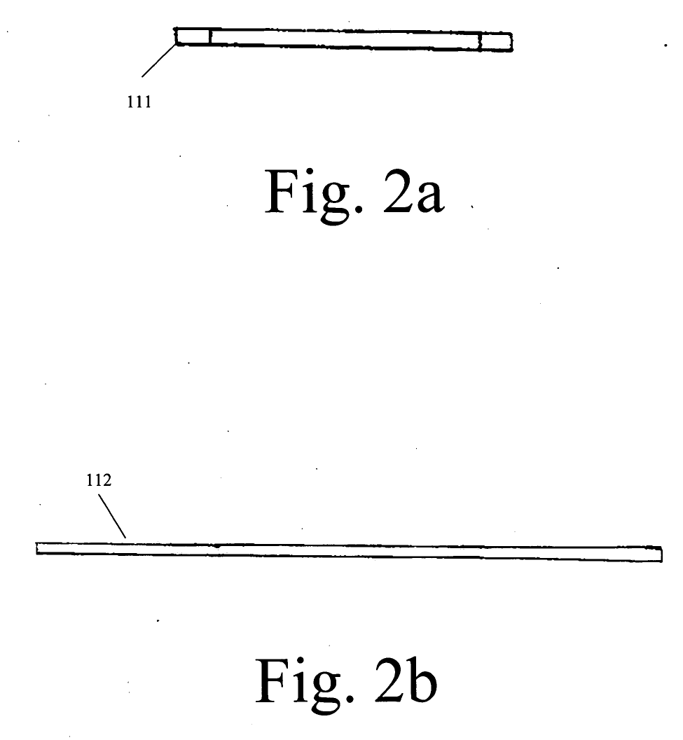

Now referring to FIG. 1b, a magnetic strip 107 that comes with minim ATM, ID, and Key cards is well known in the art. In the present invention, the magnetic strip 107 is shortened with respect to the length of the card, due to the physical size limitation imposed by the card as illustrated in FIGS. 2a and 2b, which show the a head on view of the card 111 and a side view of the card 112. The width of the magnetic strip is increased to recover the lost area as a result of the magnetic strips diminished length while still be compatible with most card reading systems known in the prior art. While magnetic technology is well known in the prior art, it has not been a goal or a consideration of the art to create a card with advantages that provide maximum benefit to the consumer while meeting institutional and market requirements and specifications.

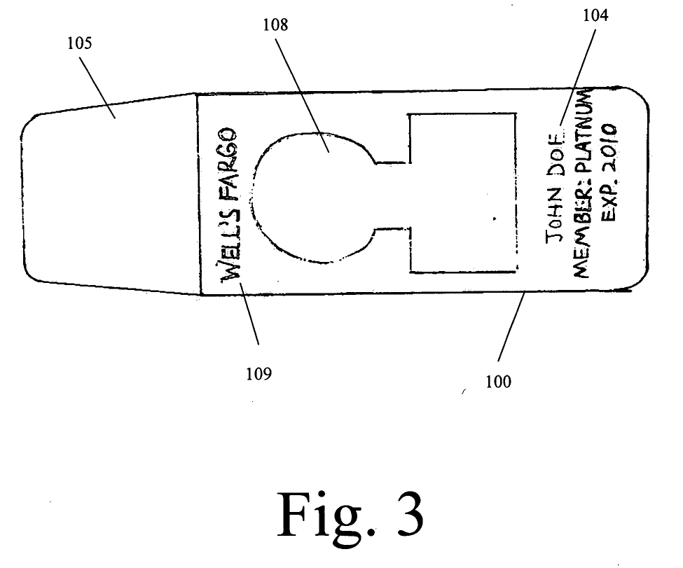

Now referring to FIG. 3, in additional to the re-configured magnetic strip, the card of the present invention seeks to improve on two more elements that have been minimized at the convenience of the customer such as the use of a personal photo 108 and the issuing institutions logo 109. On the card 100 of the present invention, the background of the card is imprinted with a personal photo 108 and the issuing banks logo 109 so that the limited surface space can be utilized for other important or necessary information such as a raised or imprinted account number.

The card 100 of the present invention also includes a small thumbnail area 105 at the top of the card that is designed to ease card handling for a user. The thumbnail area 105 is large enough for a user to handle the card without leaving fingerprints all over the surface of the card, which may interfere with a card reader 110. Additionally, the card 100 can be formed with or a user may create a hole 106 of any shape or size within the allowed thumbnail area.

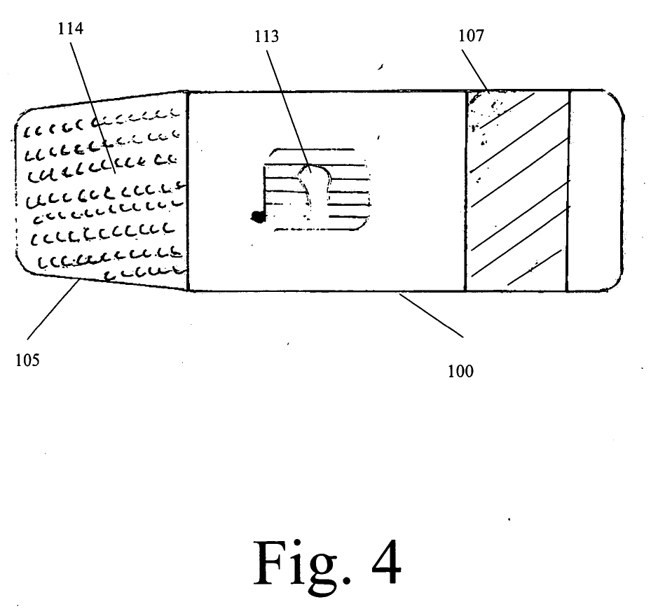

FIG. 4 illustrates an alternative embodiment of the card 100 of the present invention wherein the thumbnail area 105 is covered with a loop or hook material similar to Velcro™ that allows the card 100 to be attached to other materials. Additionally, an option information chip 113 is shown. An information chip 113 can be used in combination or in place of a magnetic strip located on the card 100. The information chip 113 operates in a similar manner to the magnetic strip in that is uses pre-stored data to identify the owner. Additionally, the chip can also be re-programmed to configure a variety of usages.

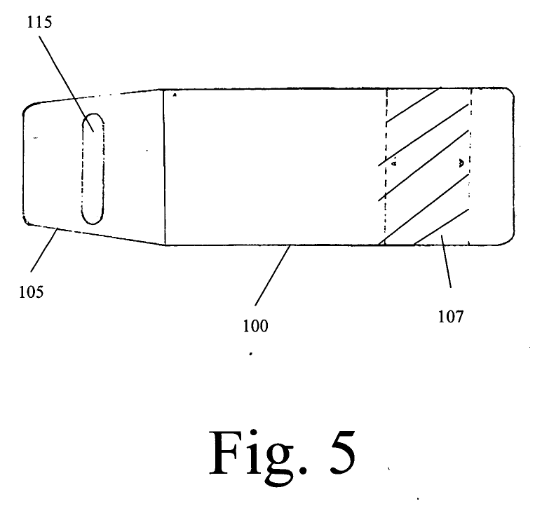

Now referring to FIG. 5, yet another alternative embodiment of the card 100 of the present invention is disclosed. In this embodiment, the thumbnail area 105 is comprised of an oval opening 115, rather than the circular opening illustrated in FIGS. 1a & 1b that is better for attaching to a key chain loop. It should be understood to one of ordinary skill in the art that the any shape of opening could be used in combination with the other elements taught by the present invention.

The present invention teaches a method of combating common fraud schemes known in the prior art. In the method taught by the present invention, also known as “Temporary Withdraw Identification Number System” or TWINS, a user must present two cards upon use. In the prior art it is common for a personal identification number system or PIN to be used which requires user to enter a PIN number upon use of the card, but many retailers do not require the entry of the PIN number when a purchase is made with an ATM card and the TWINS system aims to combat this lapse in security.

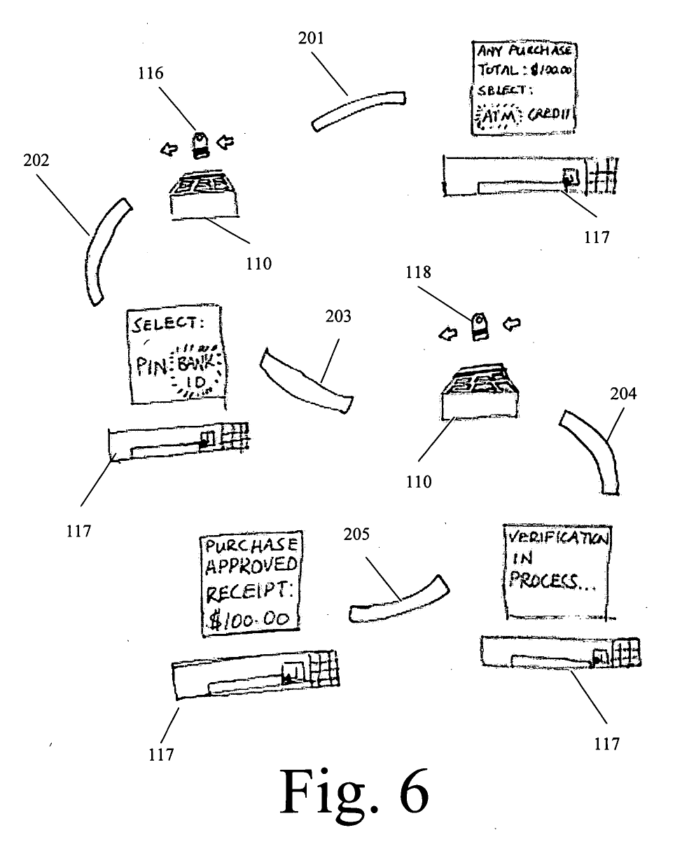

Now referring to FIG. 6, in a preferred embodiment of use, an ID card is first swiped on a reader, followed by an ATM card for that immediate transaction only. In step 201, a purchase is made and payment by ATM card is selected on the seller's computer system 117. Then in step 202, the mini ATM card 116 of the present invention is swiped by a card reader 110. Next in step 203, the user selects Bank ID over using PIN identification as the means for verification and authorization for the purchase on the seller's computer system 117. Then in step 204, the ID card 118 of the present invention is swiped by a card reader 110. Finally in step 205 the seller's computer system 117 contacts the ATM card 116 issuer and ID card 118 issuer for verification and upon receipt of verification the transaction is approved.

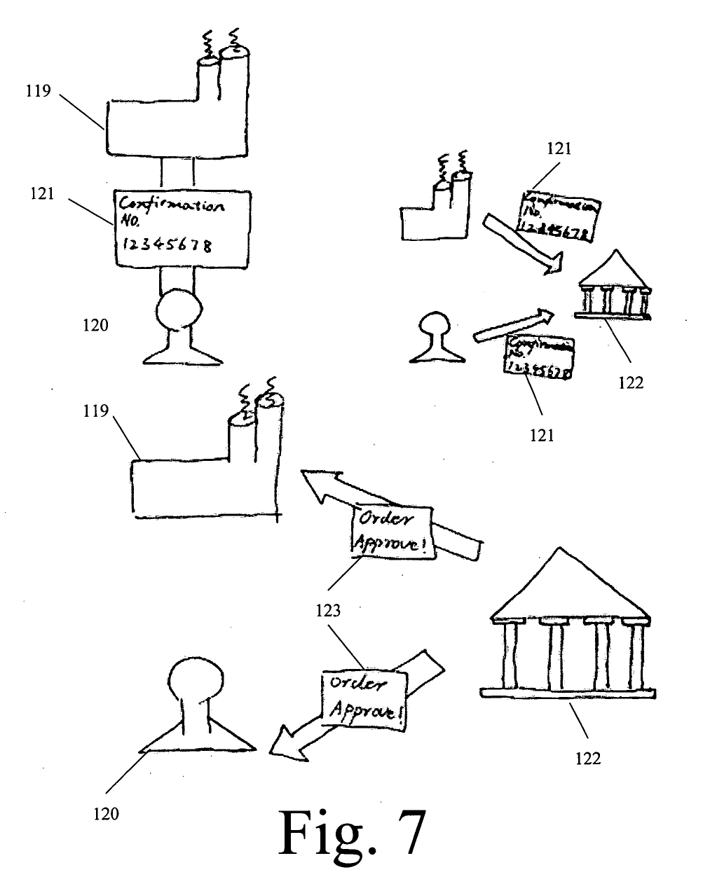

Now referring to FIG. 7, the dual verification process is illustrated for an online purchase over a multi-user network such as the Internet. In the process, when a purchase is made, both the online company 119 and user 120 generate a single confirmation number 121 for the transaction. Next both the online company 119 and the user 120 submit the confirmation number to the user's bank 122. Once the bank has received the confirmation number 121 from both online company 119 and the user 120 and confirmed that they are identical, an order approval notice 123 is provide to both online company 119 and the user 120 resulting in a complete transaction.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the designs are anticipated. Thus, the scope of the invention should be determined by the appended claims and their legal equivalents, rather than by the examples given.

The embodiments of the invention in which an exclusive property or privilege is claimed are defined as follows:

1. An ATM access card comprising:
a first area consisting of a network logo, and issuer logo, client information on the front surface of the card;
a second, thumbnail area, having an opening, and
a magnetic strip located on the back surface of the first area.

2. The ATM access card of claim 1 wherein the first area also contains a personal photo.

3. The ATM access card of claim 1 wherein the opening is round.

4. The ATM access card of claim 1 wherein the opening is a rectangle.

5. The ATM access card of claim 1 wherein the opening is oval.

6. The ATM access card of claim 1 wherein the thumbnail area is covered with loop and hook material

7. The ATM access card of claim 1 wherein an information chip is located on the first area.

8. The ATM access card of claim 7 wherein the information chip is re-programmable.

9. Temporary Withdraw Identification Number System for making an ATM purchase comprising the following means and steps:
(a) the user must present two cards upon the initiation of a transaction, an ATM card and an ID card;
(b) the mini ATM card is first swiped through a card reader, immediately followed by the ID card for the immediate transaction;
(c) said ATM card and bank ID card are to only be swiped once for a transaction;
(d) user selects purchase by ATM card on a seller's computer purchasing system;
(e) the ATM card verifies that said user has sufficient funds for the transaction is provided to the card reader by the issuing bank;
(f) seller's computer system contacts the ATM card issuer and bank ID card issuer for verification;
(g) user selects bank ID over using PIN identification as the means for verification and authorization for the purchase on the seller's computer system;
(h) the bank ID card verifies said user is the rightful owner of the ATM card; and
(i) seller receives receipt of verification and the transaction is approved.

10. Dual verification process for making an online purchase over a multi-user network comprising the following means and steps:
(a) user makes a purchase with an ATM card on a multi-user network;
(b) the seller generates a single confirmation number for the transaction;
(c) both the online company and the user submits the confirmation number to the user's bank;
(d) the bank receives the confirmation number from both the online company and the user 120, confirms that they are identical, and generates an order approval notice to both online company and the user resulting in a complete transaction.

11. A mini bank ID card comprising:
personal information; and
editable credit history for one or more bank accounts.

12. The mini bank ID card of claim 12 further comprising means which enable it to be recognized, secure, and reliable between two or more banks, thereby eliminating the need for a new application when one applies for a new account with a bank, by simply providing the new bank with the current bank ID card.
